(19) United States
(12) Patent Application Publication
(10) Pub. No.: US 2023/0336593 A1
(43) Pub. Date: Oct. 19, 2023

(54) Work in VR

(71) Applicant: Meta Platforms Technologies, LLC, Menlo Park, CA (US)

(72) Inventors: William Arthur Hugh STEPTOE, London (GB); Michael James LEBEAU, Amsterdam (NL); Björn WANBO, London (GB); Javier Alejandro Sierra SANTOS, London (GB); Vasyl BARAN, London (GB); Nils PLATH, Seattle, WA (US); James Anthony HUGHES, London (GB); Ivan SHIROKOV, London (GB); Yanni WANG, Fremont, CA (US); Jetsada MACHOM, London (GB); Nikita STARKIN, Menlo Park, CA (US); Tarang SHRIVASTAVA, Fremont, CA (US); Snigdha SINGH, London (GB); Yuge GONG, San Mateo, CA (US); Paul Ffransis MILIAN, Welwyn Garden City (GB); Peter James ALEXANDER, Maidstone (GB); Ferdinand REDELINGHUYS, Hauxton (GB)

(21) Appl. No.: 18/338,689

(22) Filed: Jun. 21, 2023

Related U.S. Application Data
(60) Provisional application No. 63/382,178, filed on Nov. 3, 2022.
(60) Provisional application No. 63/354,142, filed on Jun. 21, 2022.

(51) Int. Cl. H04L 65/401; G06V 20/20; H04L 65/1089; G06T 11/00

(52) U.S. Cl. CPC H04L 65/1089; G06T 11/00; G06V 20/20; H04L 65/4015

(57) ABSTRACT

In some implementations, the disclosed systems and methods can capture visual frames and an object manager can recognize a visual signal within the captured visual frames, such as a QR code. In some implementations, the disclosed systems and methods can participate in a private conference within a session.

### CROSS REFERENCE TO RELATED APPLICATIONS

This application claims priority to U.S. Provisional Application Numbers 63/354,142 filed Jun. 21, 2022 and titled “Artificial Reality Augments at a Predefined Object,” and 63/382,178 filed Nov. 3, 2022 and titled “Shared Artificial Reality Session with Private Conferencing,” both of which are incorporated herein by reference in their entireties.

### BACKGROUND

Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Various shared XR environments exist, allowing representations of users to move about and speak with one another. However, shared collaboration sessions that include XR environments can also suffer from interoperability challenges and security risks when implemented across a diverse set of client devices.

Artificial reality systems continue to grow in popularity. Some artificial reality environments include visual displays that correspond to real-world objects. For example, in an augmented reality or mixed reality environment, the artificial reality system can add augments that overly a real-world object or are proximate to the real-world object, such as to enhance the visual appearance of the object and/or add an interactive component to the object. Implementations that improve the design, functionality, and/or intractability of real-world objects in artificial reality environments can improve user experience.

Remote collaboration typically involves an assortment of technologies such as remote access to shared documents, various texts-based communication services (e.g., email, instant message, text message, etc.), telephone communication, and/or video calling. Such remote collaboration provides several benefits, such as reduced travel times, increased health and safety, and greater flexibility. However, remote collaboration systems continue to face problems. For example, the diverse set of client devices participating in a shared remote session can pose interoperability challenges and security risks.

### SUMMARY

Aspects of the present disclosure are directed to displaying artificial reality augments at a predefined object. An artificial reality system can capture visual frames and an object manager can recognize a visual signal within the captured visual frames, such as a QR code. The visual signal can be associated with a predefined object. For example, a real-world object (e.g., a cube, triangle, hexahedron, etc.) can comprise the visual signal, and the visual signal can be a cue to the object manager that the predefined object is present and/or available for augments. The object manager can configure the shape of the augment(s) to fit the shape of a surface of the real-world object. In some implementations, the recognized visual signal can correspond to a side of the predefined object, and the displayed augments (e.g., content and display orientation) can be configured to correspond to the side of the predefined object.

Further aspects of the present disclosure are directed to private conferencing during a shared artificial reality session. A subset of shared artificial reality session users can participate in a private conference within the session. For example, a session manager can provide private audio and/or video to members of the private conference while providing other session audio and/or video to non-members of the private conference. In some implementations, a first instance of a multiway service can support members of the private conference while a second instance of the multiway service supports non-members. The client devices for users that are non-members of the private conference may not connect to/have access to the audio/video managed by the first instance of the multiway service. Instead, these client device(s) can connect to the second instance of the multiway service that provides the non-members session audio/video that excludes the private conference audio/video.

### BRIEF DESCRIPTION OF THE DRAWINGS

FIG. 1 is a diagram of an artificial reality environment that includes an augment for a predefined real-world object.

FIG. 2 is a diagram that includes a predefined real-world object and the predefined object with displayed augments.

FIG. 3 is a flow diagram illustrating a process 300 used in some implementations for displaying artificial reality augments at a predefined object.

FIG. 4 is a conceptual diagram of a user interface for an artificial reality session.

FIG. 5 is a conceptual diagram of an example shared artificial reality session.

FIG. 6 is a system diagram of a multi-conference architecture.

FIG. 7 is a system diagram of an artificial reality system with private conferencing for a subset of participants.

FIG. 8 is a flow diagram illustrating a process used in some implementations for private conferencing during a shared artificial reality session.

FIG. 9 is a block diagram illustrating an overview of devices on which some implementations of the present technology can operate.

FIG. 10 is a block diagram illustrating an overview of an environment in which some implementations of the present technology can operate.

### DESCRIPTION

Aspects of the present disclosure are directed to displaying artificial reality augments at a predefined object. An artificial reality (XR) system can capture visual frames, for example via one or more cameras located in a real-world space. In some implementations, the XR system can present an XR environment to a user, and the XR environment can be at least partly based on the captured visual frames. For example, the XR environment can be a mixed reality (MR) or augmented reality (AR) environment that includes one or more real-world objects.

Implementations of an object manager can recognize a visual signal within the captured visual frames, such as a barcode, quick response (QR) code, predetermined visual sequence, light array, or any other suitable visual signal. For example, the visual signal can be part of and/or displayed by a real-world object (e.g., a cube, triangle, hexahedron, octahedron, etc.), and the visual signal can be a cue to the object manager that the predefined object is present and/or available for augments. In some implementations, the visual signal comprises a visual code located on a side of the real-world object. For example, each side of the real-world object can include a distinct visual code.

In some implementations, a machine learning model can process the visual frames to detect the visual signal. For example, a neural network, convolutional neural network, encoder/decoder architecture, generative adversarial network, or any other suitable machine learning model can be trained/configured to recognize the visual signal within the visual frames (e.g., camera frames).

In some implementations, the visual signal can be associated with a predefined object and/or a given side of the predefined object. For example, the predefinition can include stored characteristics of the real-world object, such as the object’s dimensions and/or object sides’ dimensions, available augment real-estate at or proximate to the object/object’s side, user preferences related to the object, and other suitable characteristics. In some implementations, the object manager can configure one or more visual augments for display at a surface/side of the real-world object, above or proximate to the real-world object, or otherwise in correspondence with the real-world object according to the predefinition.

For example, the object manager can configure the shape of the augment(s) to fit the shape of a side/surface of the real-world object. In some implementations, the recognized visual signal can correspond to a side of the predefined object, and the visual augments (e.g., content and display orientation) can be configured to correspond to the side of the predefined object. In another example, the visual augment(s) can be displayed above or proximate to (e.g., to the side, below, etc.) the predefined object, such as floating in space proximate to the object. For example, the object manager can display one or more user interface elements (e.g., buttons, interactive augments) above the object such that the user can interact with the visual augments displayed at the object (e.g., interact via tracked hand movements, tracked user gaze, etc., a driven indicator/cursor, etc.).

In some implementations, the content/functionality of the visual augments can be predefined, for example based on a context for the XR environment (e.g., running application, room/space occupied, etc.), context for the user (e.g., time of day, user activity, user location, etc.), user preferences, any combination thereof, or any other suitable context/preference. For example, when the XR environment is a workspace/office room, the predefined visual augment(s) can be an interface related to a shared workspace (e.g., visual display of colleagues, such as captured video, a hologram), real-world visual display of the user (e.g., display of the user shared with other colleagues), controls for the shared workspace (e.g., controls to select parameters for a shared whiteboard, such as writing utensil, ink color, etc.), and the like. In some implementations, the visual augments can relate to a timer application/function. For example, by interacting with the object, the user can start, stop, or pause a timer. The interactions can include touching the object, lifting the object, rotating the object, tapping the object (e.g., single tap, double tap, etc.), interacting with a visual augment displayed in correspondence with the object (e.g., a virtual button), and the like.

In some implementations, the visual augments can accompany a running application related to the XR environment, such as a video game. The visual augments can include displays that permit views into the virtual world, controls for the virtual world, and the like. The user can interact with the real-world object (e.g., touch the object, lift the object, rotate the object, tap the object, interact with a visual augment displayed in correspondence with the object, etc.) to configure the virtual world displays, perform virtual world control functions, and the like.

In some implementations, the orientation for the object can configure the visual augments and related functionality. For example, when a first side of the object is facing the user (or face down), the object manager can implement a first set of visual augment(s)/first predefined functionality and when a second side of the object is facing the user (or face down), the object manager can implement a second set of visual augment(s)/second predefined functionality. In some implementations, the object manager can detect an orientation change for the object (e.g., rotation) and dynamically adjust the visual augment(s)/functionality.

In some implementations, user interactions with the object and/or a detected orientation for the object can configure user input through a separate channel. For example, detection of an orientation for the object can mute a user during a shared audio/video call, turn on or off the user’s camera, change a user’s avatar/self-presence, adjust the user’s background, alter an audio/video filter for the user, and the like. In some implementations, detection of an orientation for the object can change a user’s availability, for example to accept calls and/or join meetings.

In some implementations, the visual augment(s) can be a panel or any other suitable display component that displays content to the user via a side of the object. For example, the visual augment(s) can correspond to a photos application that displays user photos, three-dimensional photos (e.g., photos with parallax), social media photos, and the like. In some implementations, the visual augment(s) can correspond to a social media application and the content can include social media content (e.g., posts, photos, news, video, etc.). In another example, the visual augment(s) can correspond to a media player (e.g., audio and/or video player) and the visual augment(s) can include controls for the media player and/or a display component.

In some implementations, the object manager can detect multiple real-world objects, and display augments at the corresponding multiple objects in an XR environment. For example, a first object can be detected (via a first visual signal) and a second object can be detected (via a second visual signal), where each detected object can include a predefinition. The object manager can assign a first set of visual augments/functionality to the first object and a second sent of visual augments/functionality to the second object, for example based on the predefinitions for each object.

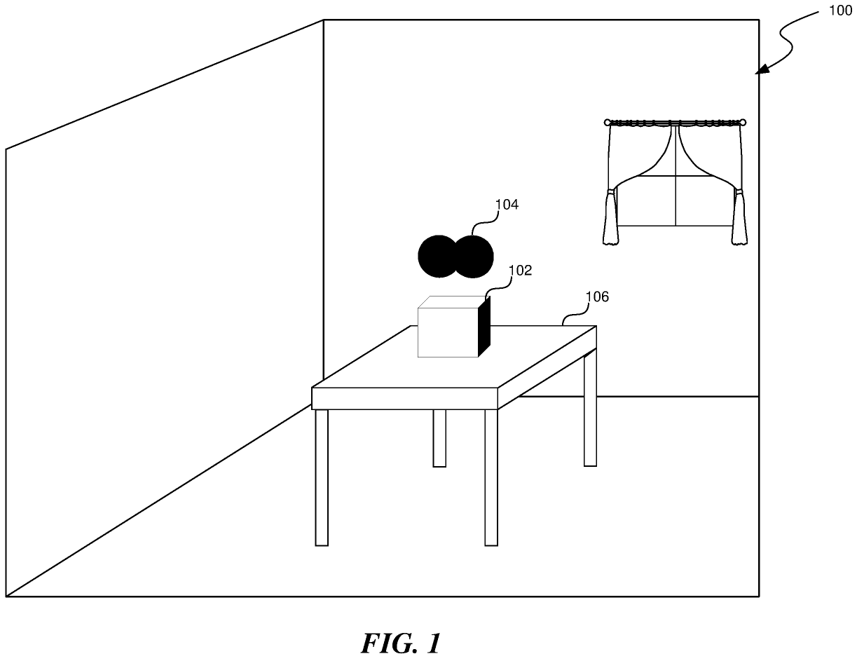

Implementations display visual augments for a predefined object in an XR environment. FIG. 1 is a diagram of an XR environment that includes an augment for a predefined real-world object. XR environment 100 includes object 102, visual augment 104, and table 106. XR environment 100 can be displayed/provided to a user via an XR system. Object 102 can be a real-world object displayed in XR environment 102. In some implementations, an object manager recognizes a visual signal at object 102, which signals to the object manager that object 102 corresponds to a predefined object. For example, parameters can be stored for object 102, such as dimensions, shapes of sides, functionality/preconfigured visual augments for object 102, for different sides of object 102, and/or for different user context(s)/XR environment context(s) while object 102 is recognized.

Visual augment 104 is displayed as an augment floating above object 102. In other example, visual augment 104 can be below, to the side, or overlaid on top of object 102. Visual augment 104 can correspond to augment(s) for an application (e.g., social media application, media application, gaming application, shared workspace application, etc.), context for XR environment 100 (e.g., shared workspace, gaming environment, home environment, etc.), context for the user (e.g., time of day, real-world location, social graph, etc.), any combination thereof, or any other suitable visual augments. Visual augments 104 can include display components, control components (e.g., controls related to applications), or other suitable visual augments. In some implementations, visual augments 104 can be three-dimensional augments or two-dimensional augments.

Object 102 can be located at any suitable location within XR environment 100. In the illustrated example, object 102 is located on table 106. The real-world appearance of object 102 can be altered by visual augments 104 such that the appearance of object 102 in XR environment 100 is different from its real-world appearance.

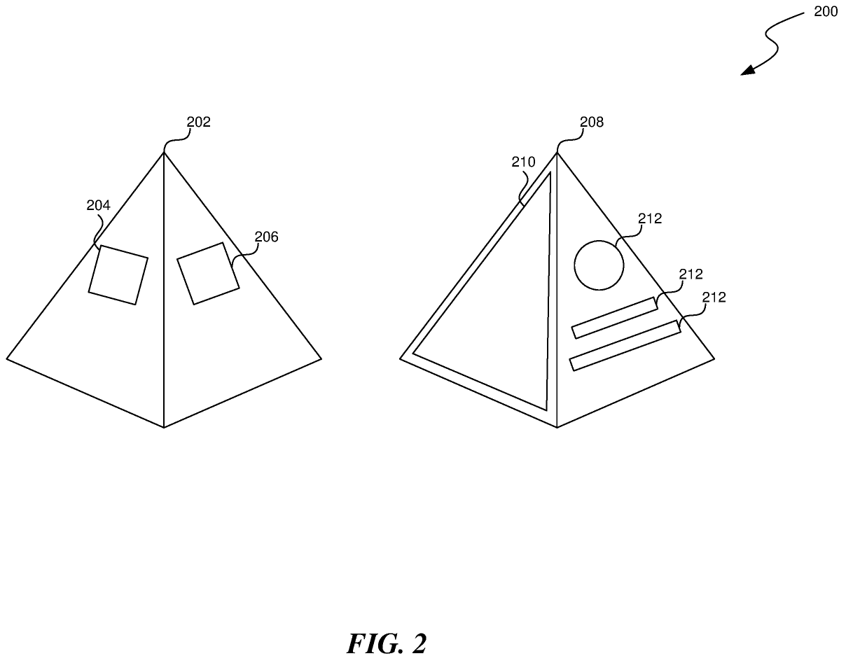

FIG. 2 is a diagram that includes a predefined real-world object and the predefined object with displayed augments. Diagram 200 includes real-world object 202, XR object 208, visual signals 204 and 206, visual augment 210, and visual augments 212.

Real-world object 202 can include visual signals 204 and 206, each corresponding to a side of real-world object 202. Visual signals 204 and 206 can be barcodes, quick response (QR) codes, predetermined visual sequences, or any other suitable visual signals. An object manager can recognize one or more of visual signals 204 and 206, and the recognition can trigger the display of augments at corresponding XR object 208.

For example, XR object 208 can be the version of real-world object 202 presented within an XR environment (e.g., presented to a user). Based on the recognition of one or more of visual signals 204 and 206, corresponding visual augment 210 and/or visual augments 212 are displayed at XR object 208. In some implementations, visual augment 210 can be shaped according to a stored/predefined shape of the side of real-world object 202 with visual signal 204 (or a stored/predefined shape of display real-estate at the side of real-world object 202). Similarly, visual augments 212 can be shaped/configured according to a stored/predefined shape of the side of real-world object 202 with visual signal 206 (or a stored/predefined shape of display real-estate at the side of real-world object 206).

Implementations of an object manager can display augment 210 at XR object 208 when it is detected that the front-facing side of real-world object 202 (e.g., the side facing a user) corresponds to visual signal 204. In another example, the object manager can display augments 212 at XR object 208 when it is detected that the front-facing side of real-world object 202 (e.g., the side facing a user) corresponds to visual signal 206. In some implementation, the object manager can detect an orientation change of real-world object 202 (e.g., change to the front-facing side of the object), and adjust the display of XR object 208 from visual augment 210 to visual augments 212, from visual augments 212 to visual augment 210, or to perform any other visual augment display transition.

Visual augments 210 and 212 can correspond to augments for an application (e.g., social media application, media application, gaming application, shared workspace application, etc.), context for an XR environment (e.g., shared workspace, gaming environment, home environment, etc.), context for the user (e.g., time of day, real-world location, social graph, etc.), any combination thereof, or any other suitable visual augments. Visual augments 210 and 212 can include display components, control components (e.g., controls related to applications), or other suitable visual augments. In some implementations, augments displayed at XR object 208 can obstruct and/or hide visual signals 204 and 206 on real-world object 202.

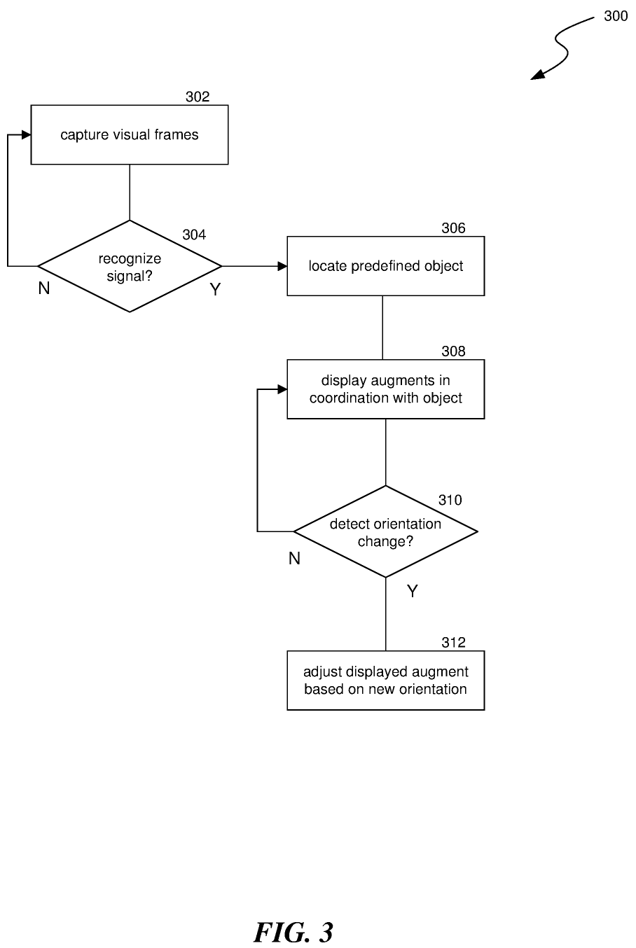

FIG. 3 is a flow diagram illustrating a process 300 used in some implementations for displaying XR augments at a predefined object. In some implementations, process 300 can be triggered when a user is presented an XR environment. In some implementations, process 300 can be performed to augment the XR environment interactions between a user and a predefined object (e.g., real-world object with a predetermined definition).

At block 302, process 300 can capture visual frames. For example, an XR system can display an XR environment to a user, and the displayed XR environment can be at least partly based on the captured visual frames. For example, the XR environment can be an AR or MR environment that includes one or more real-world objects.

At block 304, process 300 can determine whether a visual signal is recognized within the captured frames. Example visual signals include bar codes, QR codes, a visual sequences, electronic light displays, or any other suitable visual encoding of data. In some implementations, a machine learning model can process the visual frames to detect the visual signal. For example, a neural network, convolutional neural network, encoder/decoder architecture, generative adversarial network, or any other suitable machine learning model can be trained/configured to recognize the visual signal within the visual frames (e.g., camera frames).

In some implementations, a predefined object is recognized based on the recognition of the visual signal. For example, the predefinition can include stored characteristics of the real-world object, such as the object’s dimensions and/or object side’s dimensions, available augment real-estate at or proximate to the object/object’s side, user preferences related to the object, and other suitable characteristics. In some implementations, one or more visual augments can be configured for display at a surface/side of the real-world object, above or proximate to the real-world object, or otherwise in correspondence with the real-world object according to the predefinition.

In some implementations, the object can be multi-sided and a different visual signal can be located at different sides of the object. For example, detection of one of the visual signals can include detection of an orientation for the object (e.g., which side is front facing/facing the user) based on the predefined/stored visual signals and dimensions of the object.

When the visual signal is recognized, process 300 can progress to block 306. When the visual signal is not recognized, process 300 can loop back to block 302, where the visual frames can continue to be captured. For example, the XR environment (at least partly configured by the captured visual frames) can continue to be displayed to the user until a visual signal is recognized at block 304.

At block 306, process 300 can locate the predefined object. For example, using the detected visual signal and/or the known shape of the object, one or more machine learning models can locate the object within the XR environment displayed to the user. At block 308, process 300 can display one or more visual augments in coordination with the predefined object. For example, one or more visual augments can be configured for display at a surface/side of the real-world object, above or proximate to the real-world object, or otherwise in correspondence with the real-world object according to the predefinition.

In some implementations, the shape of the visual augment(s) can be configured to fit the shape of a side/surface of the real-world object. For example, the recognized visual signal can correspond to a side of the object, and the displayed augments (e.g., content and display orientation) can be configured to correspond to the side of the object. In another example, the visual augment(s) can be displayed above or proximate to the object, such as floating in space proximate to the object. For example, one or more user interface elements can be displayed above the object such that the user can interact with the visual augments displayed at the object (e.g., interact via tracked hand movements, tracked user gaze, etc., a driven indicator/cursor, etc.).

In some implementations, the content/functionality of the visual augments can be predefined, for example based on a context for the XR environment (e.g., running application, room/space occupied, etc.), context for the user (e.g., time of day, user activity, user location, etc.), user preferences, any combination thereof, or any other suitable context/preference. For example, when the XR environment is a workspace/office room, the predefined visual augment can be an interface related to a shared workspace (e.g., visual display of colleagues, such as captured video, a hologram), real-world visual display of the user (e.g., display of the user shared with other colleagues), controls for the shared workspace (e.g., controls to select parameters for a shared white board, such as writing utensil, ink color, etc.), and the like.

In some implementations, user interactions with the object can implement controls for applications, alter the display of the visual augment(s), and/or cause other functionality. The interactions can include touching the object, lifting the object, rotating the object, tapping the object (e.g., single tap, double tap, etc.), interacting with a visual augment displayed in correspondence with the object (e.g., a virtual button), and the like.

In some implementations, the orientation for the object can configure the visual augments and related functionality. For example, when a first side of the object is facing the user (or face down), first visual augment(s)/first predefined functionality can be implemented at the object and when a second side of the object is facing the user (or face down), the second visual augment(s)/second predefined functionality can be implemented at the object.

At block 310, process 300 can determine whether an orientation change has been detected for the predefined object. For example, one or more visual augments can be configured for display at a surface/side of the real-world object according to the visual signal recognized on the object and the detected orientation for the object. In some implementations, a change to the visual signal and/or a change to the front facing/user facing side of the object can be detected. In some embodiments, the change can be detected according to recognition of a different visual signal at the object and/or recognition of a rotation motion of the object (e.g., (e.g., by one or more machine learning models). When the orientation change is detected, process 300 can progress to block 312. When the orientation change is not detected, process 300 can loop back to block 308, where the visual augments can continue to be displayed in coordination with the object.

At block 312, process 300 can adjust the visual augments displayed in coordination with the object based on the new orientation detected. For example, when a first side of the object is facing the user (or face down), first visual augment(s)/first predefined functionality can be implemented at the object and when a second side of the object is facing the user (or face down), second visual augment(s)/second predefined functionality can be implemented at the object. In some implementations, a detected orientation change for the object (e.g., rotation) can trigger a dynamic adjustment of the visual augment(s)/functionality from the first visual augment(s) to the second visual augment(s).

Aspects of the present disclosure are directed to private conferencing during a shared XR session. A subset of shared XR session users can generate a private conference within the shared XR session with private audio and/or video. For example, a XR session manager can provide the private audio and/or video to members of the private conference while providing other shared XR session audio and/or video (that excludes the private conference audio/video) to non-members of the private conference.

Implementations of the shared XR session can include multiple types of users, such as XR users (i.e., users joining with XR devices) and two-dimensional users (i.e., users joining through devices with flat-panel outputs – such as laptops or mobile phones). Users of the shared XR session can participate via a client device. XR users can interact with an XR system client device (e.g., head-mounted display device, controllers, etc.) while two-dimensional users can interact with a client device comprising a conventional display (e.g., flat display, laptop, smart speaker with display, mobile phone, or any other suitable display device not capable of providing a user a three-dimensional immersive experience).

In some implementation, the XR session manager can include a Virtual rEality Real Time Service (VERTS) that shares avatar positioning and XR session audio among participating XR users/XR systems. The participant XR systems can transmit audio and avatar positioning to the VERTS. Each participant XR system can also receive, from the VERTS, XR session audio and avatar positioning information for other XR users, move user avatar according to the avatar positioning information, and output XR session audio.

In some implementations, the XR session manager can include a multiway service that manages audio and video for two-dimensional users/two-dimensional client devices. For example, the multiway service can receive audio and/or video streams from the participating client devices and provide the participating client devices audio and/or video streams from other participants. The multiway service can implement an audio and/or video call stack that provides conference services (e.g., shared audio, shared video, screen sharing, etc.) for the two-dimensional users/two-dimensional client devices.

The XR session manager can integrate XR users with two-dimensional users, for instance by integrating the functionality of the VERTS and the functionality of the multiway service. For example, a bridge service can render a video version of the shared XR session and transmit the video version to an integration service. In some implementations, participating XR systems can each transmit audio streams to the integration service. The integration service can integrate both the video version of the shared XR session and the audio from the participating XR systems to generate audio and video for the shared XR session. The integration service can then provide the integrated audio and video for the shared XR session to the multiway service for transmission to the two-dimensional client devices. In some implementations, the multiway service can also provide the integration service audio and video from the two-dimensional client devices. The integration service can then provide the audio and video from the two-dimensional client devices to the participating XR systems, which can display the video at the relevant locations of the XR environment and/or output the audio.

In some implementations, within a shared XR session, a private conference can be created with limited participants. For example, a private conference may include private audio and/or video (e.g., user video, screen sharing, media file, etc.). The private conference can have a limited set of members, such as a subset of the shared XR session user participants. In some implementations, the VERTS can implement privacy policies for audio/video provided to participant XR users/XR systems. In some implementations, multiple instances of the multiway service can create multiple segments of audio and/or video for two-dimensional user participants of the shared XR session.

For example, a first instance of the multiway service can support a private conference among members (e.g., a subset of two-dimensional users of the shared XR session). In this example, the client device(s) for two-dimensional users that are not members of the private conference may not connect to/have access to the audio/video managed by the first instance of the multiway service. Instead, the client device(s) for two-dimensional users that are not members of the private conference can connect to a second instance of the multiway service that provides the non-members XR session audio/video that excludes the private conference audio/video. This separation of client device connects/private conference data provides a concrete enforcement of privacy and confidentiality for the private conference.

Implementations of a shared XR session can include an XR environment comprising a workroom. The XR workroom can be VR, MR, AR, or any other suitable XR environment. The XR workroom can include elements for collaboration among participating users, such as desk object(s), chair object(s), whiteboard object(s), etc. Users can be represented in the workroom via any suitable user representation, such as an avatar, pass-through visuals of the user, etc. In some implementations, a desk object in the XR workroom can be segmented into defined spaces that are selected by participating users (e.g., seats at the desk). In an example, a set of users can be seated at different seats of a desk object in view of one another. The users can collaborate with one another in the XR workroom via shared audio (e.g., talking to one another), shared video (e.g., gesturing, moving, etc.), shared visual displays (e.g., shared screen, shared whiteboard, etc.), or any other suitable collaboration technique.

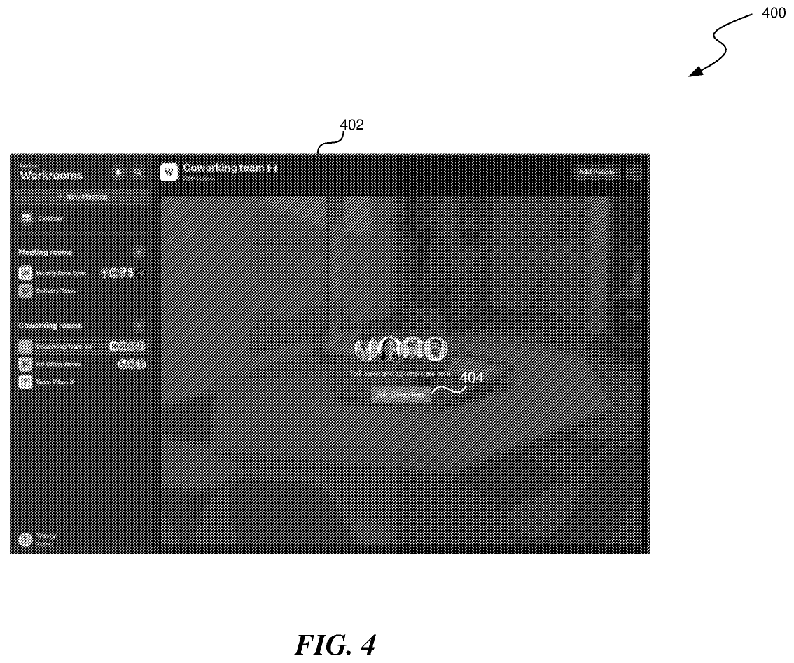

FIG. 4 is a diagram of a user interface for an artificial reality session. Diagram 400 depicts user interface 402 and element 404. A user can interact with user interface 402 to initiate a shared XR session, such as a workroom XR session. For example, the user can click element 404 (e.g., a button) to create or enter a shared workroom. Any other suitable user flows can be implemented to create/enter a shared XR session.

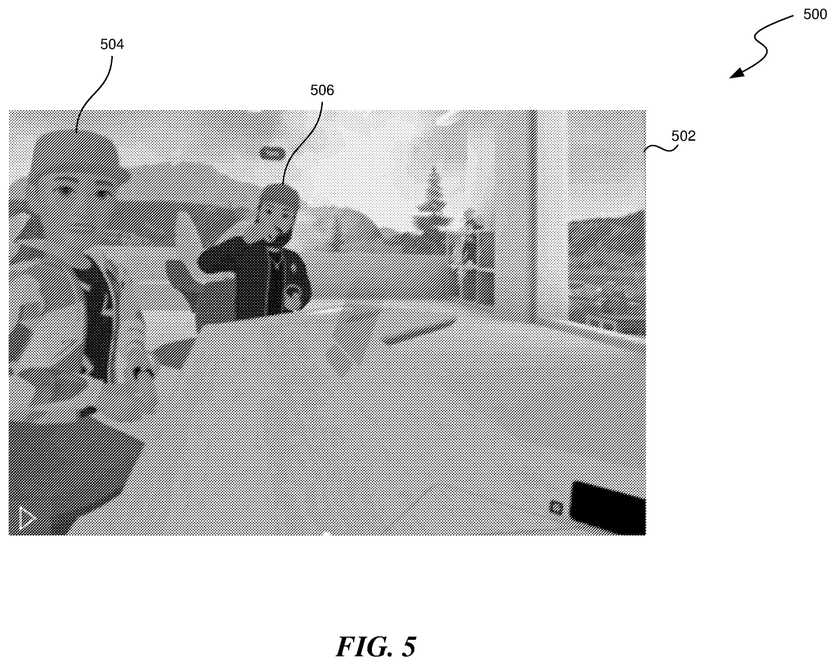

FIG. 5 is a diagram of an example shared artificial reality session. Diagram 500 depicts XR environment 502, user presence 504, and user presence 506. XR environment 502 is a shared workroom that includes user presence 504 and user presence 506. In XR environment 502, user presence 504 and user presence 506 are seated at a virtual desk object. The perspective represented by the view of XR environment 502 in diagram 500 is from the point of view of an additional user (other than user presence 504 and user presence 506). XR environment 502 can support remote coordination among these users, including shared audio and shared video (e.g., user video, screen sharing, multimedia sharing, shared XR whiteboard, etc.). Movements by user presence 504, an avatar of a corresponding user, are controlled by the movements of the corresponding user (e.g., via a controller, via cameras that capture the user’s movements, etc.).

Implementations of a shared XR session can include multiple types of users, such as XR users and two-dimensional users. Users of the shared XR session participate via a client device, such as a device that displays the shared XR session to the user. XR users can interact with an XR system client device (e.g., head-mounted display device, controllers, any other suitable display designed to provide a user a three-dimensional immersive experience.) while two-dimensional users can interact with a client device comprising a conventional display (e.g., flat display, laptop, smart speaker with display, any other suitable display device not capable of providing a user a three-dimensional immersive experience).

In some implementation, an XR session service manages the shared XR session. For example, the XR session service can include a VERTS that shares avatar positioning and XR session audio among participating XR users/XR systems. The participant XR systems can transmit audio and avatar positioning to the VERTS. Each participant XR system can also receive, from the VERTS, XR session audio and avatar positioning information for other XR users, move user avatar according to the avatar positioning information, and output XR session audio.

In some implementations, the XR session service can include a multiway service that manages audio and video for two-dimensional users/two-dimensional client devices. For example, the multiway service can receive audio and/or video streams from the participating client devices and provide the participating client devices audio and/or video streams from other participants. The multiway service can implement an audio and/or video call stack that provides conference services (e.g., shared audio, shared video, screen sharing, etc.) for the two-dimensional users/two-dimensional client devices.

The XR session service can integrate XR users with two-dimensional users, for instance by integrating the functionality of the VERTS and the functionality of the multiway service. For example, the XR session service can include a bridge service and integration service that supports communication between the VERTS and the multiway service. In some implementations, the VERTS can provide the bridge service avatar positions (e.g., according to avatar position information received from participating XR systems). The bridge service can render a video version of the shared XR session (including user avatar positions/movements). The bridge service can then transmit the video version of the shared XR session to the integration service. In some implementations, participating XR systems can each transmit audio streams to the integration service. The integration service can integrate both the video version of the shared XR session and the audio from the participating XR systems to generate audio and video for the shared XR session. The integration service can then provide the integrated audio and video for the shared XR session to the multiway service for transmission to the two-dimensional client devices.

In some implementations, the multiway service can also provide the integration service audio and video from the two-dimensional client devices. The integration service can then provide the audio and video from the two-dimensional client devices to the participating XR systems, which can display the video at the relevant locations of the XR environment and/or output the audio. Implementations of the shared XR session can provide an immersive three-dimensional shared XR session for XR users and a non-immersive (e.g., two-dimensional, video version, etc.) shared XR session for the two-dimensional users.

In some implementations, within a shared XR session a private conference can be created with limited participants. For example, a private conference may include private audio and/or video (e.g., screen sharing, media file, etc.). The private conference can have a limited set of members, such as a subset of the shared XR session user participants (e.g., one or more XR users and one or more two-dimensional users). In some implementations, the VERTS can implement privacy policies for audio/video provided to participant XR users/XR systems. In some implementations, multiple instances of the multiway service can create multiple segments of audio and/or video for two-dimensional user participants of the shared XR session. For example, an instance of the multiway service can support a private conference among members (e.g., a subset of two-dimensional users of the shared XR session). In this example, the client device(s) for two-dimensional users that are not members of the private conference may not connect to/have access to the audio/video managed by the instance of the multiway service. This separation of functionality provides a concrete enforcement of privacy/confidentiality for the private conference.

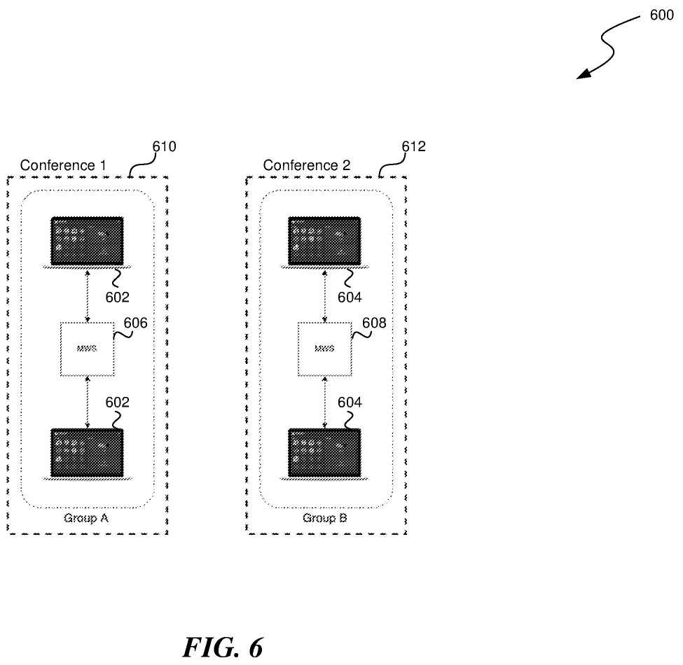

FIG. 6 is a system diagram of a multi-conference architecture. System 600 includes user devices 602, user devices 604, multiway service 606, multiway service 608, and conferences 610 and 612. In the depicted example, users 602 are members of conference 610 and users 604 are members of conference 612. Multiway service 606 can support audio and video for conference 612 and multiway service 608 can support audio and video for conference 614. The separation of the audio/video for these conferences between two individual multiway instances supports private conferencing among the individual members of conference 610 and conference 612. In some implementations, an XR session service can implement a shared XR session that supports multiple multiway instances and private conferencing for subset(s) of participating users.

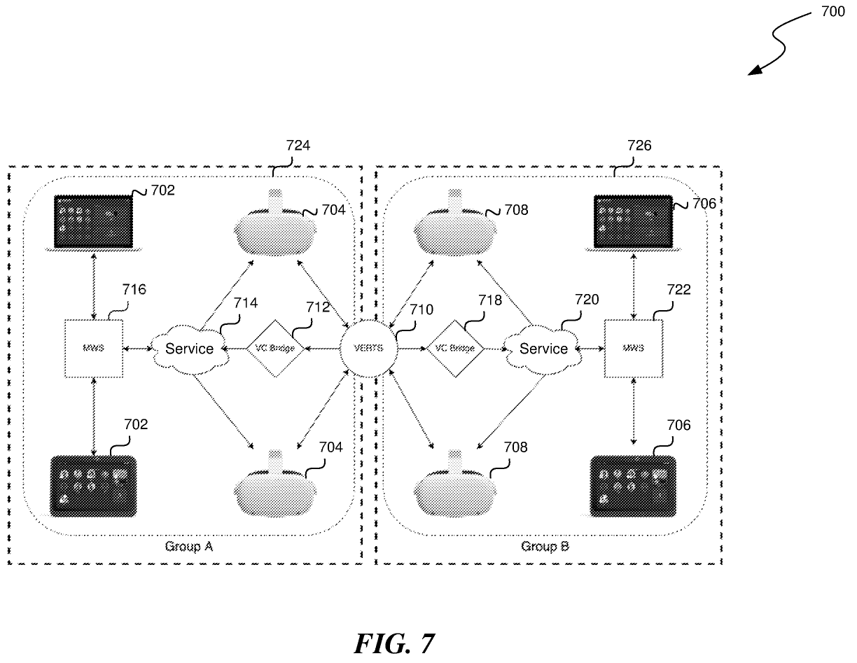

FIG. 7 is a system diagram of an artificial reality system with private conferencing for a subset of participants. System 700 depicts user devices 702, XR devices 704, user devices 706, XR devices 708, VERTS 710, bridge 712, integration service 714, multiway service 716, bridge 718, integration service 720, multiway service 722, user group 724, and user group 726. In the illustrated implementation, client devices 702 are associated with two-dimensional users that are part of user group 724, XR devices 704 are associated with XR users that are part of user group 724, client devices 706 are associated with two-dimensional users that are part of user group 726, XR devices 708 are associated with XR users that are part of user group 726. VERTS 710 can connect to each of XR devices 704 and 708, or XR devices associated with XR users from both user group 724 and user group 726. System 700 includes multiple instances of a multiway service, in particular one for each of user group 724 and 726.

During a shared XR session supported by system 700, user group 724 (e.g., client devices 702 and XR devices 704) can initiate a private conference. VERTS 710 and multiway service 716 can, in combination, enforce privacy for this initiated conference. In the illustrated embodiment, VERTS 710 implements privacy rules to separate private audio/video received from XR devices 704 during the private conference. Private conference data (e.g., audio) from XR devices 704 received at VERTS 710 can be processed and transmitted to the devices comprised by user group 724. For example, VERTS 710 can transmit this private conference data to XR devices 704 and multiway service 716 (via bridge 712 and integration service 714), and multiway service 716 can then transmit the private conference data to client devices 702. In some examples, VERTS 710 can transmit private conference data to XR devices 704 via integration service 714.

While VERTS 710 implements privacy for conference data from XR devices 704, multiway service 716 implements privacy for conference data from client devices 702. Rather than enforce privacy rules similar to those enforced by VERTS 710, the multiple instances of multiway service 716 and 722 separate the audio/video data from two-dimensional users/client devices 702 and 706. In this example, client devices 702, which correspond to two-dimensional users of user group 724, transmit private conference data to multiway service 716. Multiway service 716 receives private conference data from client devices 702 and VERTS 710 (e.g., via bridge 712 and integration service 714). Multiway service 716 then processes the received data to support the private conferencing for user group 724 (e.g., implement an audio conference, video conference, screen sharing, etc.) and transmits private conference data (e.g., audio and/or video) to client devices 702. In this example, multiway service 716 does not receive audio/video data from client devices 706, as this data is received/managed by multiway service 722. The separation of data and client device connections achieved by the multiple instances of multiway services enforces private conferencing within the shared XR session.

In this example, while the devices/users of user group 724 (e.g., client devices 702 and XR devices 704) receive private conference data (e.g., audio and video), the devices/users of user group 726 (e.g., client devices 706 and XR devices 708) can receive other shared XR session data (e.g., audio and video other than the private conference data). In some implementations, VERTS 710 and multiway service 722 can similarly enforce privacy for a private conference initiated for user group 726. In some examples, the shared XR session can include multiple private conferences, a first for user group 724 and a second for user group 726. In this example, VERTS 710 and multiway service 716 can enforce privacy of audio/video data for the first private conference and VERTS 710 and multiway service 722 can enforce privacy of audio/video data for the second private conference.

In some implementations, one of client devices 706 can join a private conference for user group 724 by disconnecting from multiway service 722 and connecting to multiway service 716. For example, one of client devices 706 can request permission to join the private conference for user group 724 and, if granted by an administrator or moderator, the one of client device 706 can disconnect from multiway service 722 and connect to multiway service 716. In some implementations, prior to the connection switch, the one client device 706 does not have access to the private conference data because multiway service 722 does not receive/manage this data. The connection switch provides the one client device 706 access to the private conference data managed by multiway service 716.

In some implementations, the private conference for a subset of users in a shared XR session can include an audio conference, an audio and video conference, a conference with a screen shared (e.g., user screen sharing), a conference with a shared virtual workspace (e.g., shared whiteboard), or any other suitable audio and video data. In some implementations, a private conference can be initiated for a given user during a shared XR session by: a) a user clicking a button or otherwise providing user input that triggers a private conference that includes the given user; b) the given user entering a predefined volume/location of the XR environment (e.g., room, predefined three-dimensional shape, etc.) associated with the private conference and receiving permission from an administrator moderator; c) a user sitting at a table associated with the private conference (e.g., after receiving permission from an administrator or moderator); or d) any other suitable manner of initiating/joining a private conference.

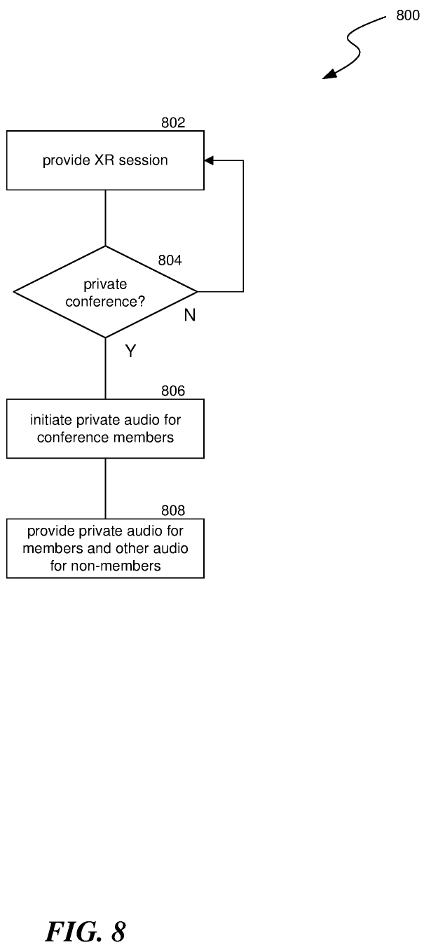

FIG. 8 is a flow diagram illustrating a process used in some implementations for private conferencing during a shared artificial reality session. In some implementations, process 800 can be triggered when a private conference is initiated during a shared XR session. Process 800 can be implemented by a XR service, such as a shared XR session manager, at any cloud device, edge device, client device, any combination thereof, or any other suitable device(s).

At block 802, process 800 can provide a shared XR session to participating users. For example, the shared XR session can include a diverse set of users, such as two-dimensional users (e.g., users that connect to the shared XR session via client devices with conventional display capabilities) and XR users (e.g., users that connect to the shared XR session via XR system client devices capable of immersive three-dimensional environment displays).

In some implementations, a XR service provides audio and video of the shared XR session to a) one or more XR users via a first service, and b) one or more two-dimensional users via two instances of a second service. For example, the first service can provide a XR environment representation (e.g., three-dimensional immersive environment) of the shared XR session and the two instances of the second service can provide a two-dimensional display (non-immersive video version) of the shared XR session.

At block 804, process 800 can detect initiation of a private conference. For example, a user can initiate a private conference for a subset of the XR environment participants. The subset can include one or more two-dimensional users and one or more XR users. When a private conference is initiated, process 800 can progress to block 806. When a private conference is not initiated, process 800 can loop back to block 802, where a shared XR session can continue to be provided until detection of a private conference.

At block 806, process 800 can initiate private audio and/or video for conference members. For example, a logical segmentation can be generated the segments the private conference audio/video from the general shared XR session audio/video. At block 808, process 800 can provide private audio and/or video for members of the conference and other audio and/or video that excludes the private audio/video for non-members of the conference. For example, the XR service provides private audio/video to the users that are members of the private conference and shared XR session audio/video that excludes the private audio/video to the users that are non-members of the private conference.

In some implementations, client devices associated with two-dimensional users that are members of the private conference are connected to a first instance of the second service while client devices associated with two-dimensional users that are non-members of the private conference are connected to a second instance of the second service. For example, the audio/video received by two-dimensional users that are members of the private conference (e.g., private conference audio/video) can be provided by a first instance of the second service and the audio/video received by two-dimensional users that are non-members of the private conference (e.g., general XR session audio/video) can be provided by a second instance of the second service.

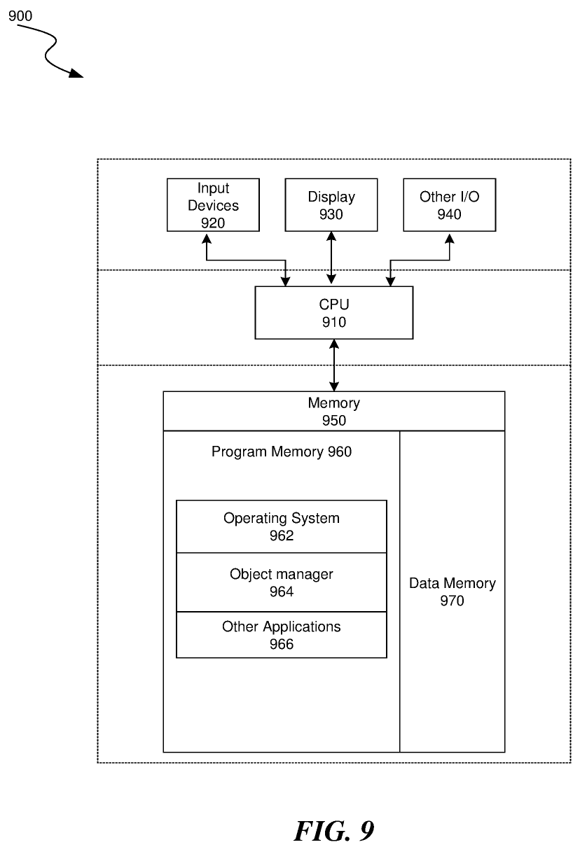

FIG. 9 is a block diagram illustrating an overview of devices on which some implementations of the disclosed technology can operate. The devices can comprise hardware components of a device 900 as shown and described herein. Device 900 can include one or more input devices 920 that provide input to the Processor(s) 910 (e.g., CPU(s), GPU(s), HPU(s), etc.), notifying it of actions. The actions can be mediated by a hardware controller that interprets the signals received from the input device and communicates the information to the processors 910 using a communication protocol. Input devices 920 include, for example, a mouse, a keyboard, a touchscreen, an infrared sensor, a touchpad, a wearable input device, a camera- or image-based input device, a microphone, or other user input devices.

Processors 910 can be a single processing unit or multiple processing units in a device or distributed across multiple devices. Processors 910 can be coupled to other hardware devices, for example, with the use of a bus, such as a PCI bus or SCSI bus. The processors 910 can communicate with a hardware controller for devices, such as for a display 930. Display 930 can be used to display text and graphics. In some implementations, display 930 provides graphical and textual visual feedback to a user. In some implementations, display 930 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 940 can also be coupled to the processor, such as a network card, video card, audio card, USB, firewire or other external device, camera, printer, speakers, CD-ROM drive, DVD drive, disk drive, or Blu-Ray device.

In some implementations, the device 900 also includes a communication device capable of communicating wirelessly or wire-based with a network node. The communication device can communicate with another device or a server through a network using, for example, TCP/IP protocols. Device 900 can utilize the communication device to distribute operations across multiple network devices.

The processors 910 can have access to a memory 950 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 950 can include program memory 960 that stores programs and software, such as an operating system 962, object manager 964, and other application programs 966. Memory 950 can also include data memory 970, which can be provided to the program memory 960 or any element of the device 900.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

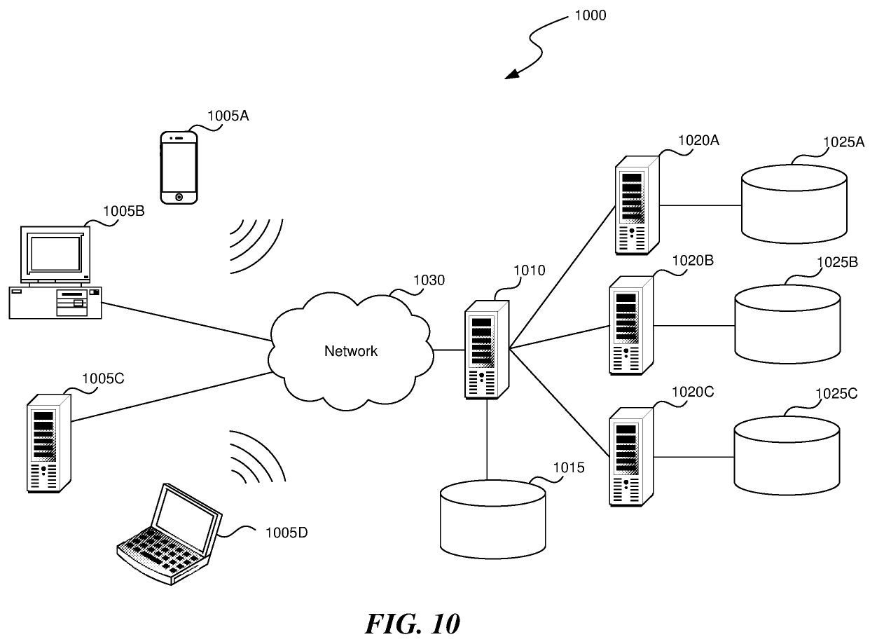

FIG. 10 is a block diagram illustrating an overview of an environment 1000 in which some implementations of the disclosed technology can operate. Environment 1000 can include one or more client computing devices 1005A-D, examples of which can include device 900. Client computing devices 1005 can operate in a networked environment using logical connections through network 1030 to one or more remote computers, such as a server computing device.

In some implementations, server 1010 can be an edge server which receives client requests and coordinates fulfillment of those requests through other servers, such as servers 1020A-C. Server computing devices 1010 and 1020 can comprise computing systems, such as device 900. Though each server computing device 1010 and 1020 is displayed logically as a single server, server computing devices can each be a distributed computing environment encompassing multiple computing devices located at the same or at geographically disparate physical locations. In some implementations, each server 1020 corresponds to a group of servers.

Client computing devices 1005 and server computing devices 1010 and 1020 can each act as a server or client to other server/client devices. Server 1010 can connect to a database 1015. Servers 1020A-C can each connect to a corresponding database 1025A-C. As discussed above, each server 1020 can correspond to a group of servers, and each of these servers can share a database or can have their own database. Databases 1015 and 1025 can warehouse (e.g., store) information. Though databases 1015 and 1025 are displayed logically as single units, databases 1015 and 1025 can each be a distributed computing environment encompassing multiple computing devices, can be located within their corresponding server, or can be located at the same or at geographically disparate physical locations.

Network 1030 can be a local area network (LAN) or a wide area network (WAN), but can also be other wired or wireless networks. Network 1030 may be the Internet or some other public or private network. Client computing devices 1005 can be connected to network 1030 through a network interface, such as by wired or wireless communication. While the connections between server 1010 and servers 1020 are shown as separate connections, these connections can be any kind of local, wide area, wired, or wireless network, including network 1030 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user’s visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user’s eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. Pat. Application No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

We claim:

1. A method for displaying augments at a predefined object in an artificial reality (XR) environment, the method comprising:
capturing, by an XR system, one or more visual frames, wherein the XR system displays the XR environment to a user;
recognizing, within the visual frames, a visual signal located at a real-world object, wherein the real-world object is recognized as a predefined object based on the recognized visual signal; and
displaying, within the XR environment, one or more visual augments in coordination with the predefined object.

2. A method for private conferencing during a shared artificial reality (XR) session, the method comprising:
providing a shared XR session to a plurality of users, wherein a XR service provides audio and video of the shared XR session to a) one or more XR users of the plurality of users via a first service, and b) one or more two-dimensional users of the plurality of users via two instances of a second service; and
triggering a private conference with members comprising at least one XR user and at least one two-dimensional user, wherein the XR service provides private audio to the members and provides shared XR session audio that excludes the private audio to users that are non-members of the private conference, wherein the audio received by members that comprise two-dimensional users is provided by a first instance of the second service and the audio a received by non-members that comprise two-dimensional users is provided by a second instance of the second service.

3. A computing system as shown and described herein.
